(19) United States
(12) Patent Application Publication
(10) Pub. No.: US 2009/0250158 A1
(43) Pub. Date: Oct. 8, 2009

(54) Method for Transferring a Multilayer Body and a Transfer Film

(76) Inventors: Christina Streb, Abtwil (CH); Felix Alex Eschenmoser, Sempach LU (CH); Hans-Jörg Alois Schmidlin, Malters LU (CH); Achim Hansen, Zug (CH)

Correspondence Address: Charles R. Hoffmann;Hoffmann & Baron, 6900 Jericho Turnpike, Syosset, NY, 11791, US

(21) Appl. No.: 12/084,194

(22) PCT Filed: Oct. 24, 2006
(86) PCT No.: PCT/EP2006/010208

§ 371 Date: Apr. 25, 2008

(30) Foreign Application Priority Data
Oct. 27, 2005 (DE) 102005051725.0

(51) Int. Cl. B32B 37/02

(52) U.S. Cl. 156/219; 156/230

(57) ABSTRACT

The invention concerns a method of transferring a multi-layer body onto a substrate and a transfer film and a method of producing a transfer film. A transfer film (8) is provided, which has a carrier film (81), a single-layer or multi-layer decorative layer and a release layer (82) which permits separation of the decorative layer from the carrier film. A first portion (35) of the decorative layer forms the multi-layer body to be applied to the substrate. The transfer film (8) and a release film (91) are placed upon each other. A first adhesive layer (86) arranged between the decorative layer and the release film (91) is activated in a second portion (36) of the decorative layer, that adjoins the first portion (35) of the decorative layer that is associated with the multi-layer body and however in the first portion (35) of the decorative layer is not activated, is not provided or is deactivated. The release film (91) is pulled off the transfer film (8), wherein the second portion (36) of the decorative layer, in which the first adhesive layer (86) is activated, adheres to the release film (91) and is pulled off the carrier film with the release film, and the first portion (35) of the decorative layer remains on the carrier film (81). The transfer film is then placed on the substrate and the first portion of the decorative layer, that is not released with the release film (91) from the carrier film (81), is applied to the substrate.

The invention concerns a method of transferring a multi-layer body onto a substrate, a method of producing a transfer film and a transfer film produced by means of that method.

Embossing films, in particular hot embossing films, are used to a wide extent for the transfer of security and/or identification elements onto security documents, for example passports or credit cards. Thus for example DE 100 13 410 A1 describes the production of a laminate forming an identity card, a credit card or the like, in which disposed between two adjacent cover layers is a security and/or identification element formed by the decorative layer of a hot embossing film. The security element includes a transparent lacquer or polymer layer into which structures having an optical-diffraction effect are applied. The transparent lacquer or polymer layer is provided with a reflection-enhancing layer which can be a metal layer or a dielectric layer. The security element further has an adhesive layer by means of which the security element is fixed to the lower cover layer. The operation of applying the security element to the lower cover layer is effected in such a way that the hot embossing film is placed with the adhesive layer on the corresponding side of the lower cover layer and pressed against the cover layer under the action of heat and pressure, in the portion of the hot embossing film which is to be transferred. When the carrier film is pulled off the portion of the decorative layer of the hot embossing film, that is to form the security element, adheres firmly to the lower cover layer. The other portions of the decorative layer are pulled off together with the carrier film. Here the operation of applying the hot embossing film by pressure is effected by means of a suitably structured tool which applies suitable pressure to the hot embossing film only where the security element is later to be present.

In such a procedure for transferring the decorative layer of a hot embossing film from a carrier film onto a substrate, generally the decorative layer of the embossing film is torn away from the substrate along the edge of the portion, that is to be transferred, of the decorative layer, in the operation of pulling off the transfer film. That can give rise to problems in particular when using transfer films having thicker layers or having layers involving specific properties such as for example a high level of abrasion resistance.

Thus EP 0 708 935 A1 proposes cutting a marking component out of a hot embossing film comprising a polyester carrier, an optical element including a hologram, a protective layer and an adhesive layer, and gluing the marking component onto a projecting adhesive film. The marking component forms the optical element to be transferred. A multi-layer body which is already of the shape of the element to be transferred is thus provided on the carrier film. The carrier film projects beyond the multi-layer body and serves for positioning the multi-layer body on the substrate.

That method however suffers from the disadvantage that cutting a marking component out of a transfer or laminating film and subsequently laminating same onto a projecting carrier is a technically highly complicated and expensive operation and accurate positioning of the marking component in the appropriate relationship on the carrier is possible only with a high level of technological complication and expenditure. Furthermore with that method an optical marking which is usually outside the region to be transferred is no longer available.

Now the object of the invention is to provide an improved method of transferring a multi-layer body onto a substrate and a transfer film suitable for that purpose.

That object is attained by a method of transferring a multi-layer body onto a substrate, in which a transfer film is provided, which has a carrier film, a single-layer or multi-layer decorative layer and a release layer which permits separation of the decorative layer from the carrier film, wherein a portion of the decorative layer forms the multi-layer body to be transferred. In that method the transfer film and a release film are placed upon each other. A first adhesive layer arranged between the decorative layer and the release film is activated in a second portion of the decorative layer, that adjoins a first portion of the decorative layer that is associated with the multi-layer body, and however is not activated, is not provided or is deactivated in the first portion of the decorative layer. Then the release film is pulled off the transfer film, wherein the second portion of the decorative layer, in which the first adhesive layer is activated, adheres to the release film and is pulled off the carrier film with the release film, and the first portion of the decorative layer remains on the carrier film. The transfer film is then placed on the substrate and the first portion of the decorative layer, that is not released with the release film from the carrier film, is applied at least region-wise to the substrate.

That object is further attained by a method of producing a transfer film and a transfer film produced by means of that method. In this method of producing a transfer film a base film is provided, which has a carrier film, a single-layer or multi-layer decorative layer and a release layer which permits separation of the decorative layer from the carrier film, and in which a first portion of the decorative layer forms the multi-layer body to be transferred. The base film and a release film are placed upon each other. A first adhesive layer arranged between the decorative layer and the release film is activated in a second portion of the decorative layer, that adjoins the first portion of the decorative layer that is associated with the multi-layer body, and however not activated, not provided or deactivated in the first portion of the decorative layer. The release film is pulled off the base film, wherein the second portion of the decorative layer, in which the first adhesive layer is activated, adheres to the release film and is pulled off the carrier film with the release film, and the first portion of the decorative layer however remains on the carrier film.

By means of the release film and partial activation of the adhesive layer, the decorative layer is removed from the carrier film prior to transfer of the multi-layer body in the portions which are later not to be transferred onto the substrate. In that way it is for example possible for the multi-layer body to be transferred onto a substrate, for example a passport, by means of an inexpensive roll laminator of a simple structure. In addition it is possible in that fashion to avoid “fraying” which occurs due to the decorative layer breaking in the edge region of the multi-layer body to be transferred. The adhesive and structural properties of the release film can be optimized independently of other demands to which for example the target substrate is subjected, so that the decorative layer breaks through smoothly in the edge regions when the release film is pulled off, and no other troublesome effects occur.

In that respect it is also possible for the first portion of the decorative layer to be transferred only region-wise onto the substrate, for example for a first “critical” edge of the multi-layer body which is to be transferred to be generated by means of the release film and for a second edge to be generated by means of a embossing punch or a structured roll of a roll laminator.

The first adhesive layer arranged between the decorative layer and the release film is partially activated, partially deactivated or partially provided, wherein a suitable choice of the adhesive layer and the release film in the second portion of the decorative layer, in which the adhesive layer is activated, not deactivated or applied, provides for adhesion between the decorative layer and the release layer, which is greater than the adhesion between the transfer film and the decorative layer. The release layer and the adhesive layer are further so selected that, in the first portion of the decorative layer, in which the adhesive layer is not activated, deactivated or not applied, the adhesion between the decorative layer and the release layer is less than the adhesion between the carrier film and the decorative layer.

In accordance with a preferred embodiment of the invention the first portion of the decorative layer which is to be applied to the substrate is enclosed or bordered by a second portion of the decorative layer which is pulled off the carrier film with the release film. That second portion of the transfer film is then further preferably enclosed or bordered by a third portion of the decorative layer, which is not released from the carrier film with the release film, and preferably still remains on the carrier film even upon application of the first portion of the decorative layer to the substrate. Thus it is for example possible that the first portion of the decorative layer, to be applied to the substrate, forms a corridor enclosing the peripheral edge of the first portion, of a width of preferably between 2 and 10 mm, separating the first portion from the third portion of the decorative layer. In that case the first portion of the decorative layer can be applied to the substrate for example by means of a embossing punch or a suitably structured roll of a roll laminator. In that case the third portion can further be provided with optical marks used for example for application of the first portion of the decorative layer in accurate register relationship.

Preferably a film of a paper material is used as the release film. Such material has good adhesion properties and is extremely inexpensive.

In accordance with a preferred embodiment of the invention the first adhesive layer is applied in the first and second portions over the full surface area to the decorative layer and is partially activated in the second portion before the release film is pulled off. That activation step can preferably be effected by means of a heated embossing punch which activates the hot adhesive layer by means of heat and pressure in the second region but not in the first region. Furthermore it is also possible that a UV-activatable adhesive is applied as the first adhesive layer in the first and second portions over the full surface area to the decorative layer and partially activated by means of UV radiation in the second region but not in the first region. Thus, the first adhesive layer can be the adhesive layer which then also provides for fixing the transferred multi-layer body on the substrate in the transfer step which takes place subsequently. That results in a particularly inexpensive solution as the first adhesive layer is used both for partial release of the decorative layer in the second portion and also for fixing the transferred multi-layer body on the target substrate. That method then also further affords the advantage that a hot embossing punch projecting beyond the first portion of the decorative layer or a roll laminator formed by two mutually opposite heated rolls can be used for fixing the multi-layer body on the target substrate, whereby it is also possible to ensure that the edge regions of the multi-layer body adhere firmly to the substrate.

In accordance with a further embodiment of the invention the first adhesive layer is deactivated in the first portion by means of overprinting with a deactivation layer, for example a lacquer layer. It is also possible for the first adhesive layer to be applied by printing to the decorative layer or the release film in the second portion but not in the first portion. In that way it is possible that the release film can be laminated onto the transfer film by means of two oppositely disposed rolls and it is possible in that way to dispense with the use of hot embossing punches.

Preferably a second adhesive layer is then also provided between the decorative layer and the release film besides the first adhesive layer. In that respect it is possible for the second adhesive layer to be applied to the decorative layer and the first adhesive layer to the release film or for firstly the second adhesive layer to be applied to the decorative layer and then the second adhesive layer to the first adhesive layer.

In that respect preferably different adhesives are used for the first and second adhesive layers. Thus, respective hot melt adhesives are used for the first and second adhesive layers, which however have different activation temperatures. The first adhesive layer involves using an adhesive layer with an activation temperature which is lower than the activation temperature of the second adhesive layer. Thus it is possible for the first adhesive layer to be partially activated without activating the second adhesive layer. In addition it is also possible for a cold adhesive or a UV-activatable adhesive to be used for the first adhesive layer and a hot melt adhesive used for the second adhesive layer.

In accordance with a preferred embodiment of the invention the decorative layer and possibly further layers present in the transfer layer (first and second adhesive layers) is at least region-wise severed in edge regions of the first portion in which the first and second portions adjoin each other. In that respect, the step of severing those layers can be effected before or after the release film is placed on the decorative layer. Preferably in that case the decorative layer is severed by means of stamping after the release film is placed on the decorative layer, in which case the stamping depth of the stamping tool is preferably so selected that the layers of the transfer film, which are disposed on the carrier film, as well as the release film, but not the carrier film itself, are severed. A further preferred feature provides that a combined embossing/stamping tool is used, which at the same time activates the first adhesive layer in the second portion and at least region-wise stamps through the decorative layer and the release film in the boundary interface region between the first and second portions.

After activation of the first adhesive layer and before the release layer is pulled off, a further embodiment of the invention provides that a further film is applied to the side of the release film, that is remote from the decorative layer, and fixed by means of a third adhesive layer. That further film is then pulled off the transfer layer, together with the release film adhering to the further film. By means of using such a further film, the method can be improved in particular for those variants in which the release film is stamped therethrough in edge regions of the first portion with the decorative layer. By means of the further film, stamped-out portions of the release film are secured, the release film as such is stabilized and thus reliable removal of the second portions of the decorative layer from the carrier film is guaranteed.

The invention is described by way of example hereinafter by means of a number of embodiments with reference to the accompanying drawings in which:

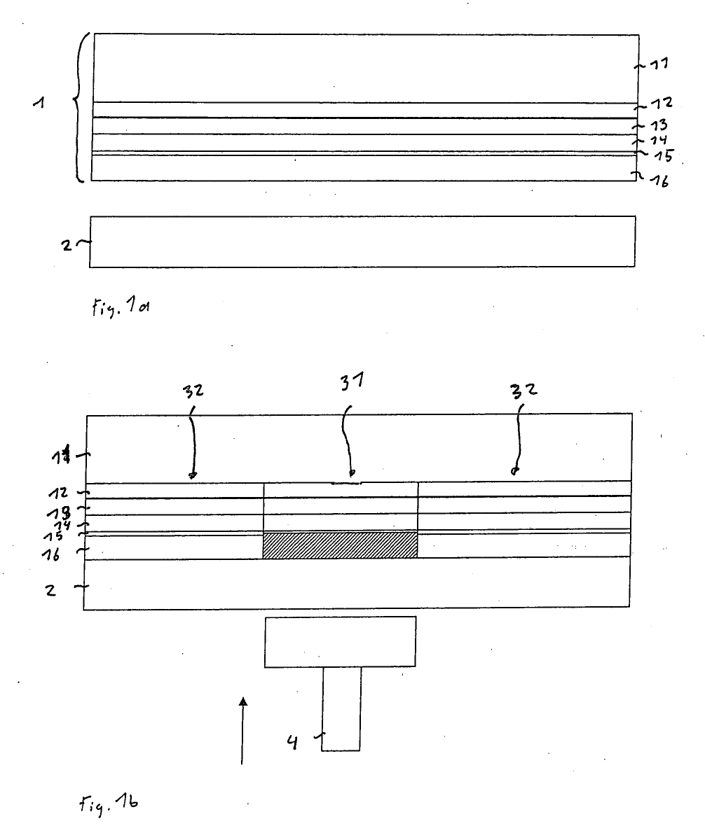

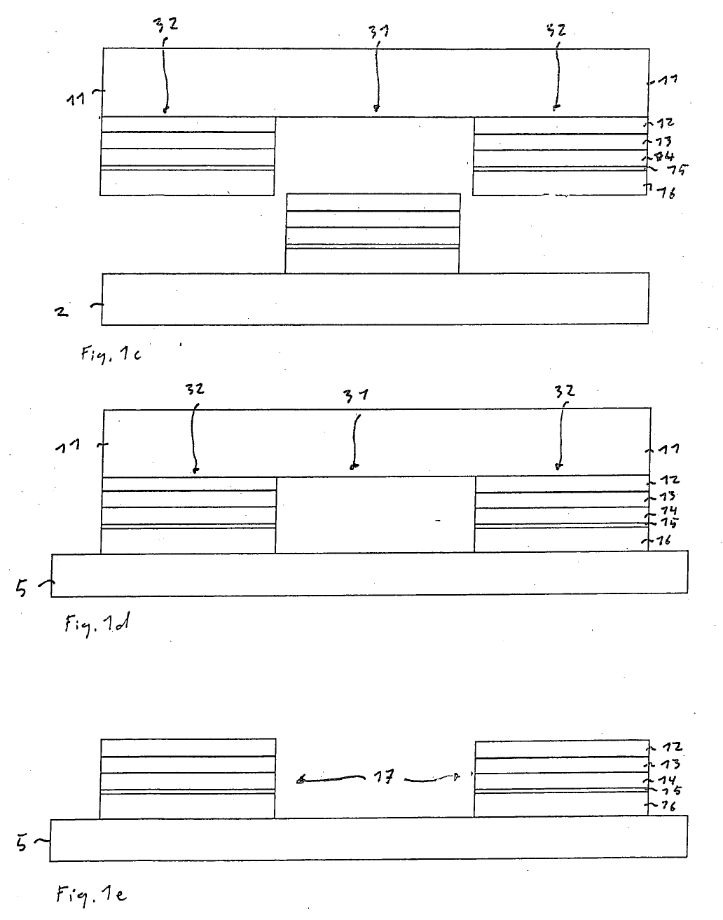

FIGS. 1a through 1e show diagrammatic views to illustrate various method steps of a method according to the invention of transferring a multi-layer body onto a substrate in accordance with a first embodiment,

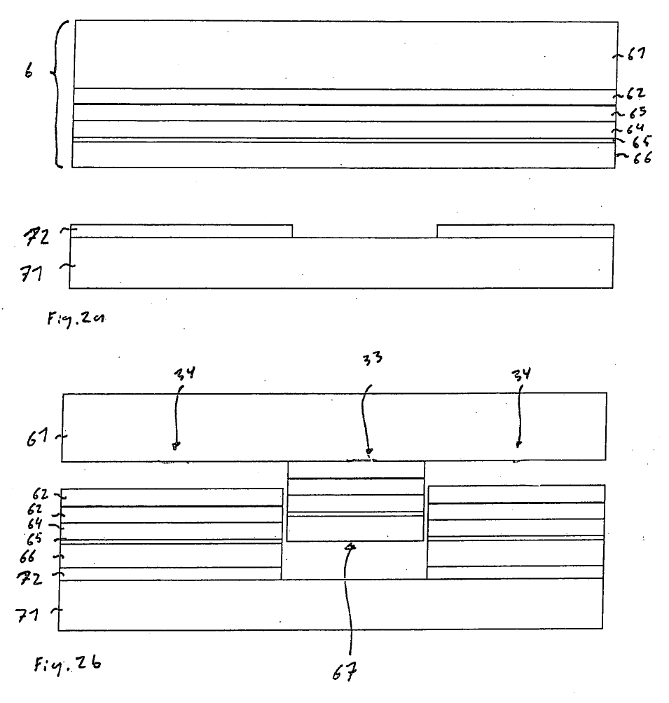

FIGS. 2a and 2b show diagrammatic views to illustrate method steps of a method according to the invention of transferring a multi-layer body onto a substrate in accordance with a second embodiment, and

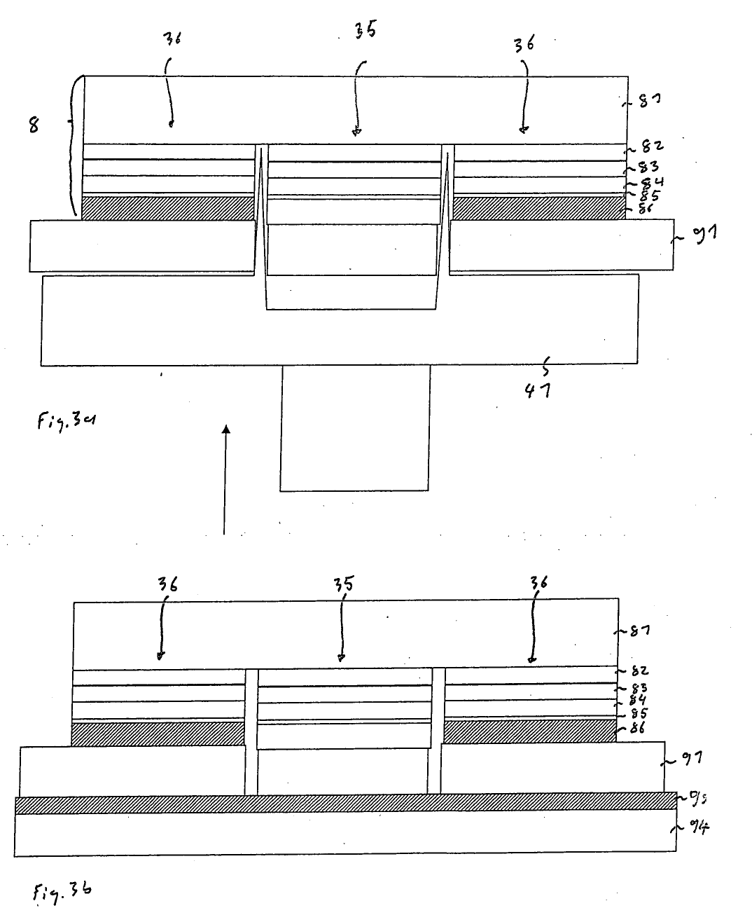

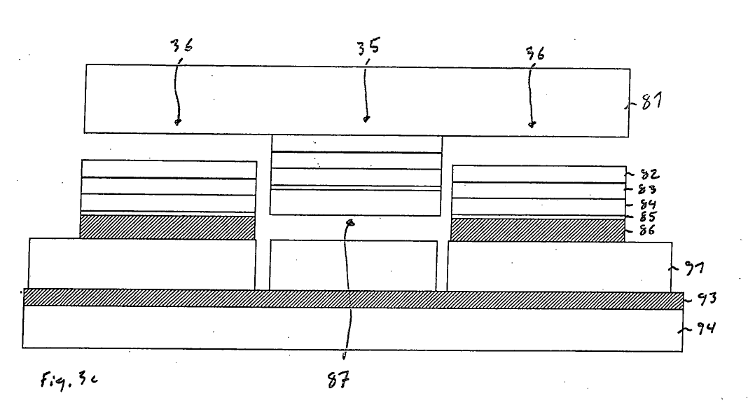

FIGS. 3a through 3c show diagrammatic views to illustrate various method steps of a method according to the invention of transferring a multi-layer body onto a substrate in accordance with a further embodiment of the invention.

FIGS. 1a shows a transfer film 1 and a release film 2. In this case the transfer film 1 comprises a carrier film 11 and a multi-layer decorative layer formed by a release layer 12, a protective lacquer layer 13, a replication lacquer layer 14, a reflection layer 15 and an adhesive layer 16.

The carrier film 11 is preferably a polyester film of a thickness of between 6 and 60 μm. In addition it is also possible for the carrier film 11 to be of a multi-layer structure and to comprise for example a polyester film and a paper layer of a thickness of between 30 and 500 μm, which is applied to the polyester film by lamination.

The decorative layer is now successively built up by applying further layers on the carrier film 11. For that purpose firstly the release layer 12 is applied to the carrier film 11. The release layer preferably comprises a wax-like material which softens in particular due to the heat which occurs in a hot embossing operation and permits reliable separation of the decorative layer from the carrier film 11. The thickness of the release layer 12 is in this case between about 0.3 and 1.2 μm.

The protective lacquer layer 13 is then applied in a similar layer thickness. In this case it is also possible for the protective lacquer layer 13 also to take over the function of the release layer 12 and accordingly both to permit separation of the decorative layer from the carrier film and also to protect the decorative layer from mechanical actions and environmental influences. The composition of such a release and protective lacquer layer could be as follows:

| Components | Parts by weight |
|---|---|
| High-molecular PMMA resin | 2000 |
| Silicone alkyd, oil-free | 300 |
| Non-ionic wetting agent | 50 |
| Methyl ethyl ketone | 750 |
| Low-viscosity nitrocellulose | 12000 |
| Toluene | 2000 |
| Diacetone alcohol | 2500 |

In that respect it is also possible for the protective lacquer layer 13 to be colored or to contain micro- and nanoparticles.

The replication lacquer layer 13 comprises a thermoplastic layer in which a diffractive surface structure is replicated by means of the action of heat and pressure by means of an embossing tool. The replication lacquer layer is of a thickness of between about 0.5 and 1.5 μm. The diffractive surface structure is for example a hologram or a Kinegram® or any other diffraction-optically active grating structure which is defined by structural parameters such as grating frequency, structure depth, structure form and azimuth angle. The replication lacquer layer 14 is preferably applied over the full surface area to the protective lacquer layer 13 by means of a printing process, for example an intaglio printing screen roller, and then dried in a drying passage. Replication of the diffractive surface structure is then effected by means of a rotating embossing cylinder or by stroke embossing. In addition it is also possible for a UV-crosslinkable lacquer to be used as the replication lacquer layer and for the diffractive surface structure to be produced by means of UV replication.

The reflection layer 15 is then applied to the replication lacquer layer 14. The reflection layer 15 is preferably a metal layer of chromium, copper, silver or gold or corresponding alloys which is vapor deposited under vacuum in a thickness of between 0.01 and 0.04 μm. In addition it is also possible to apply an optical separation layer instead of the reflection layer 15. The optical separation layer is preferably an HRI or LRI layer (HRI=high refraction index; LRI=low refraction index), the refraction index of which differs markedly from that of the replication lacquer layer 14 so that the diffraction-optical effect produced by the diffractive surface structure introduced into the replication lacquer layer becomes visible to the viewing person. In this case the optical separation layer is formed for example by a vapor-deposited layer of a metal oxide, metal sulfide, titanium dioxide etc. of a thickness of between 10 and 50 nm.

Furthermore it is also possible, instead of or in addition to the layers 13 and 14, to introduce into the decorative layer still further layers which generate an optically variable effect. Thus it is possible for example to provide a thin film layer system generating a viewing angle-dependent color shift effect, a layer of a crosslinked (cholesteric) liquid crystal material or a partially provided metal layer, in the decorative layer. The decorative layer can also include one or more (colored) further lacquer layers but also stabilization layers, for example a polyester film of a thickness of between 4 and 12 μm. In addition it is also possible for the decorative layer to include one or more electrically conductive or semiconducting layers which implement an electrical circuit, for example an RFID tag. The decorative layer can also include one or more layers of a magnetic material and an (electro-)luminescent material.

The adhesive layer 16 is then applied to the decorative layer, in a layer thickness of between about 0.3 and 5 μm. In this case the adhesive layer 16 comprises a thermally activatable adhesive and is applied to the decorative layer over the full surface area for example by means of a doctor.

The release film 2 is a film of a paper material, for example paper material based on natural or synthetically produced fibers.

It is however also possible for the release film 2 to comprise a multi-layer film body, for example comprising a polyester film and a paper web applied by lamination.

Now in a first step the release film 2 is placed on the transfer film 1. The adhesive layer 16 is then activated in a portion of the decorative layer by means of heat and pressure so that adhesion is produced between the decorative layer of the transfer film 1 and the release film 2, which is greater than the adhesion between the carrier film 11 and the decorative layer. Thus for example Figure lb shows the transfer film 1 comprising the carrier film 11, the release layer 12, the protective lacquer layer 13, the replication lacquer layer 14, the reflection layer 15 and the adhesive layer 16 which is placed on the release film 2. The adhesive layer 16 is now activated in a portion 31 by means of a hot embossing punch 4 by the hot embossing punch 4 being pressed from the side of the release film 2 against the film stack in mutually superposed relationship thereof. In addition it is also possible for the embossing punch 4 to be pressed against the film stack from the side of the carrier film 11 in the region 31. The adhesive layer 16 in contrast is not activated in an adjacent portion 32 of the decorative layer.

Activation of the adhesive layer can further also be effected by means of laser.

If now, as shown in FIG. 1c, the release film 2 is pulled off the transfer film 1 then the portion 31 of the decorative layer, in which the adhesive layer 16 has been activated, adheres to the release film 2 and is pulled therewith off the carrier film 11. In contrast, in the portion 32 of the decorative layer, in which the adhesive layer has not been activated, the decorative layer formed from the layers 12 through 16 remains on the carrier film 11.

The carrier film 11 produced in that way and provided with a decorative layer which is pulled region-wise off the carrier film can now be stored as an intermediate product, packaged and shipped for further use, for example at passport issuing locations. In that case the portion 32 of the decorative layer can be of a simple geometrical configuration and can be used for example as a security seal for product safeguarding, for safeguarding bank notes and value-bearing documents or for safeguarding identification papers such as corporate passes and passports. It is however also possible for the portions 32 of the decorative layer, that remain on the carrier film 11, to be of a more complex outline shape and for example to have a figurative outline shape.

The carrier film produced by the above-described method steps, with the layers 12 through 16 which are present in the portions 32 on the carrier film 11, is thus placed on a substrate 5 for example in a passport issuing office, as shown in FIG. 1d. The substrate 5 is for example a paper or plastic material substrate provided with an individualized print thereon, for example a passport picture and personal data of the passport holder.

The film stack formed by the transfer film and the substrate 5 is then introduced into a roll laminator which activates the adhesive layer 16 by heat and pressure and joins the portion 32 of the decorative layer fixedly to the substrate 5 by means of the adhesive layer 16. The carrier film 11 is then pulled off. As shown in FIG. 1e, a multi-layer body 17 which involves the outline shape of the portion 32 and is made up of the layers 12 through 16 thus remains on the substrate. In addition it is also possible here for the release layer 12 not to be released with the decorative layer from the carrier film as shown in FIG. 1e, but to remain on the carrier film 11.

Furthermore it is also possible for release to be effected after the arrangement has been wound up and put into intermediate storage at a later moment in time, for example shortly before application at the processing organization.

A further embodiment by way of example of the invention will now be described with reference to FIGS. 2a and 2b.

FIG. 2a shows a transfer film 6 which is made up of a carrier film 61, a release layer 62, a protective lacquer layer 63, a replication lacquer layer 64, a reflection layer 65 and an adhesive layer 66. In this case the layers 61 through 66 are made up like the layers 11 through 16 of the transfer film 1 shown in FIG. 1. In addition FIG. 2 shows a release film 71 to which a further adhesive layer 72 has been partially applied for example by means of an intaglio printing screen roller. The adhesive layer 72 is a cold adhesive which is activatable by pressure or a UV-crosslinkable adhesive. The release film 71 with the partial adhesive layer 72 is now placed on the carrier film 6 and then the adhesive layer 72 is activated by the release film 71 and the transfer film 61 being pressed upon or after application of the release film 71 the resulting film stack is exposed over the entire surface area thereof by means of a UV lamp from the side of the release film 71 or the carrier film 61.

In addition it is also possible for the adhesive layer 72 to comprise a thermally activatable adhesive and to be applied over the full surface area to the carrier film 71. The adhesive layer 72 is then partially activated by applying heat and pressure for example by means of a hot embossing stamp (see FIG. 1b). Furthermore it is possible for the adhesive layer 72 to be applied over the full surface area to the release film 71 and for then portions of the adhesive layer 72 to be deactivated by applying by printing a lacquer layer serving as a deactivation layer. In that case the adhesive layer 72 can comprise a thermally activatable adhesive, a cold adhesive or a UV-activatable adhesive. After the release film 71 has been placed on the transfer film 6 the adhesive layer 72 is activated over the full surface area by heat, pressure or UV radiation, in which case, in the portions in which the deactivation layer is applied by printing to the adhesive layer 72, an adhesion between the decorative layer and the release film 71, that is greater than the adhesion between the carrier film 61 and the decorative layer is prevented.

Toner as is used in printing is also suitable as the adhesive for the adhesive layer 77. Application of the adhesive layer can then also be effected by means of a (laser) printer. Furthermore it is possible for the adhesive layer 72 to be applied by means of an inkjet printer.

As shown in FIG. 2b the release film 71 is then pulled off the carrier film 6, in which case the decorative layer remains on the carrier film 61 in a portion 33 in which the adhesive layer 72 was not provided, had not been activated or was deactivated by means of the deactivation layer, while in the other portion 34 the decorative layer consisting of the layers 62 through 66 is pulled off the carrier film 61, with the release film 71.

The transfer film produced in that way can now be used to apply a multi-layer body 67 formed by the portion 33 of the decorative layer to a substrate, in a similar manner to the transfer film shown in FIG. d.

A further embodiment of the invention will now be described with reference to FIGS. 3a through 3c.

FIG. 3a shows a transfer film 8 which includes a carrier film 81, a release layer 82, a protective lacquer layer 83, a replication lacquer layer 84, a reflection layer 85 and an adhesive layer 86. In this case the layers 81 through 86 are of a nature corresponding to the layers 11 through 16 of FIG. 1a.

The transfer film 8 is now placed on a release film 91 which for example is formed by a paper web brought into overlapping relationship with the transfer film 8. The adhesive layer 86 is then activated in portions 36 of the decorative layer by means of a tool 41 and at the same time the boundary interface regions between the portion 36 and a portion 35 are at least region-wise stamped therethrough, by means of that tool. The tool 41 is a hot embossing tool which is of a specific design configuration and which in the region of those edge regions is provided with blade-like extensions which sever the release film 91 and the subjacent transfer layer of the transfer film 8. In that case the stamping depth is so selected that the decorative layer of the transfer film is at least partially cut through but the carrier film 81 is not cut through by the stamping operation and at least still has sufficient inherent stability to ensure reliable detachment of the release film 91 from the transfer film 8. As shown in FIG. 3a the tool 41, in the portion 36, has punch surfaces which are of a configuration corresponding to the portion 36 and which cause activation of the adhesive layer 86 by heat and pressure when the tool 41 is pressed onto the film stack. Provided in the adjoining edge region are cutting extensions in groove form or spike form which ensure at least region-wise severing of the decorative layer in the hot embossing operation. The adhesive layer 86 is not activated by the tool 41 in the portion 35 delimited by the portion 36.

It is particularly advantageous in that respect if the release film 91 is not completely severed by the tool 41 in the edge region between the portions 65 and 36, that is to say it is not completely stamped out in the form of a marking or token and still remains joined to the remaining region of the release film by way of one or more legs.

Now in the next step the release film 91 can be pulled off the carrier film 81 with the portion 36 of the decorative layer, in which the adhesive layer 86 is activated and thus adheres to the release film 91.

It is particularly advantageous however if, before the release film 91 is pulled off, a further film 94 is applied to the side of the release film 91, that is remote from the decorative layer, and is glued to the release film 91 by means of an adhesive layer 93. The film 94 is in this case preferably a film of a paper material, for example a further paper web which is brought into overlapping relationship with the release film 91 and which is provided over the full surface area with a cold adhesive layer forming the adhesive layer 93. The film 94 is then pressed against the release film 91 whereby the adhesive layer 93 is activated and the release film 91 glued to the film 94.

Then, as shown in FIG. 3c, the release film 91 together with the film 94 is pulled off the transfer film 8, in which case the portion 36 of the decorative layer adheres to the release film 91 and is pulled off the carrier film 81 with the release film.

In this case, the film 94 on the one hand ensures that the release film 91 is reliably pulled off the transfer film 8, even if the release film 91 has been stamped through by the tool 41 over a large surface area. Furthermore, this ensures that no stamped-out pieces of the release film 91 remain on the transfer film after the transfer film 91 has been pulled off and can hinder the further application procedure.

After the release film 91 has been pulled off there is thus a transfer film with the portion 35 of the decorative layer, which can be applied to a substrate as the multi-layer body 87, as described with reference to FIGS. 1d and 1e.

1. A method of transferring a multi-layer body onto a substrate, wherein in the method a transfer film is provided, which has a carrier film, a single-layer or multi-layer decorative and a release layer, which permits separation of the decorative layer from the carrier film and in which a portion of the decorative layer that forms the multi-layer body, is applied to the substrate, wherein
the transfer film and a release film are placed upon each other, a first adhesive layer arranged between the decorative layer and the release film is activated in a second portion of the decorative layer, that adjoins a first portion of the decorative layer that is associated with the multi-layer body, and however is not provided or is deactivated in the first portion of the decorative layer, the release film is pulled off the transfer film, wherein the second portion of the decorative layer, in which the first adhesive layer is activated, adheres to the release film and is pulled off the carrier film with the release film, and the first portion of the decorative layer remains on the carrier film, and the transfer film is placed on the substrate and the first portion of the decorative layer, that is not released with the release film from the carrier film, is applied at least region-wise to the substrate.

2. A method as set forth in claim 1, wherein a film of a paper material is used as the release film.

3. A method as set forth in claim 1, wherein the first adhesive layer is applied in the first and second portions over the full surface area to the decorative layer and is partially activated in the second portion before the release film is pulled off.

4. A method as set forth in claim 3, wherein a UV-activatable adhesive is used as the first adhesive layer and the first adhesive layer is partially activated by means of UV radiation.

5. A method as set forth in claim 3, wherein the first adhesive layer is deactivated in the first portion by means of overprinting with a deactivation layer.

6. A method as set forth in claim 3, wherein the first adhesive layer is deactivated in the first portion by means of radiation.

7. A method as set forth in claim 1, wherein the first adhesive layer is applied by printing to the decorative layer in the second portion but not in the first portion.

8. A method as set forth in claim 1, wherein the first adhesive layer is applied by printing to the release film in the second portion but not in the first portion.

9. A method as set forth in claim 1, wherein the release film is applied by lamination to the transfer film by means of two oppositely disposed rolls.

10. A method as set forth in claim 1, wherein there is provided a second adhesive layer between the decorative layer and the release film besides the first adhesive layer.

11. A method as set forth in claim 10, wherein the second adhesive layer is applied to the decorative layer and the first adhesive layer is applied to the release film.

12. A method as set forth in claim 10, wherein firstly the second adhesive layer is applied to the decorative layer and then the first adhesive layer is applied to the second adhesive layer.

13. A method as set forth in claim 10, wherein different adhesives are used for the first adhesive layer and the second adhesive layer.

14. A method as set forth in claim 13, wherein hot melt adhesives which have different activation temperatures are used as the first and second adhesive layers, the activation temperature of the first adhesive layer being less than that of the second adhesive layer.

15. A method as set forth in claim 13, wherein a cold adhesive is used for the first adhesive layer and a hot adhesive is used for the second adhesive layer.

16. A method as set forth in claim 1, wherein the decorative layer is severed in the region in which the first and second portions adjoin each other.

17. A method as set forth in claim 16, wherein the decorative layer is separated by means of stamping.

18. A method as set forth in claim 17, wherein the decorative layer is processed with a hot embossing punch which simultaneously activates the first adhesive layer in the second portion and punches through at least region-wise the decorative layer and the release film in the boundary region between the first and second portions.

19. A method as set forth in claim 1, wherein after activation of the first adhesive layer and before the release film is pulled off, a further film provided with a third adhesive layer is applied to the side of the release film, that is remote from the decorative layer, the third adhesive layer is activated and then the release film with the further film adhering thereto is pulled off the decorative layer.

20. A method of producing a transfer film which permits the transfer of a multi-layer body onto a substrate, wherein in the method a base film is provided, which has a carrier film, a single-layer or multi-layer decorative layer and a release layer which permits separation of the decorative layer from the carrier film and in which a first portion of the decorative layer forms the multi-layer body to be transferred, wherein
the base film and a release film are placed upon each other, a first adhesive layer arranged between the decorative layer and the release film is activated in a second portion of the decorative layer, that adjoins the first portion of the decorative layer that is associated with the multi-layer body, and however is not provided or is deactivated in the first portion of the decorative layer, and the release film is pulled off the base film, wherein the second portion of the decorative layer, in which the first adhesive layer is activated, adheres to the release film and is pulled off the carrier film with the release film, and the first portion of the decorative layer remains on the carrier film.

21. A hot embossing film, for the transfer of a multi-layer body onto a substrate, wherein the transfer film has a carrier film, a single-layer or multi-layer decorative layer and a release layer which permits separation of the decorative layer from the carrier film, and wherein the hot embossing film is produced in accordance with the method as set forth in claim 20.
